(19) United States
(12) Patent Application Publication
(10) Pub. No.: US 2023/0218949 A1
(43) Pub. Date: Jul. 13, 2023

(54) GOLF SWING ANALYSIS METHOD AND GOLF SWING ANALYSIS SYSTEM

(71) Applicant: Techno Craft Corporation, Niigata-ken (JP)

(72) Inventor: Masanari Togasaka, Niigata-ken (JP)

(73) Assignee: Techno Craft Corporation, Niigata-ken (JP)

(21) Appl. No.: 18/187,093

(22) Filed: Mar. 21, 2023

Related U.S. Application Data
(63) Continuation-in-part of application No. 17/656,188, filed on Mar. 23, 2022.

(30) Foreign Application Priority Data
Mar. 25, 2021 (JP) 2021-051224

(51) Int. Cl. A63B 24/00; A63B 60/46; A63B 69/36

(52) U.S. Cl. CPC A63B 24/0006; A63B 60/46; A63B 69/36; A63B 2024/0015; A63B 2102/32

(57) ABSTRACT

The virtual play system is composed of a mobile terminal 2 worn by a player P, a virtual play display terminal 6 provided with a display unit 86, and a cloud server 4 capable of communicating with the mobile terminal 2 and the virtual play display terminal 6. The mobile terminal 2 includes a data analysis unit that transmits first measurement data obtained by measuring and quantifying an actual motion of player P during play and second measurement data obtained by measuring and quantifying the motion of player P during simulated play to the cloud server 4, and the cloud server 4 includes a virtual play data generation unit that calculates virtual play data based on the first measurement data and the second measurement data, and the virtual play display terminal 6 displays the virtual play data.

### RELATED APPLICATIONS

This application is a continuation-in-part of and claims priority to U.S. patent application Ser. No. 17/656,188, filed Mar. 23, 2022 entitled Golf Swing Analysis System, which claims benefit and priority to Japanese Patent Application No. 2021-05124, filed Mar. 25, 2021, both of which are hereby incorporated herein by reference in their entireties.

### FIELD OF THE INVENTION

The present invention relates to a golf swing analysis method and golf swing analysis system.

### BACKGROUND OF THE INVENTION

Conventionally, it has already proposed in Japanese Patent No. 6938030 filed and registered by the applicant of the present application in Japan for a swing analysis system of a golf club in which speed and acceleration of wrist and waist when a golf player actually swings a golf club are measured using an acceleration measurement unit built into a wristwatch type terminal or a mobile terminal, on the other hand, flight distance of the ball hit by the player at the golf club is calculated by a flight distance calculation unit, and a relationship between the acceleration and angular velocity of these wrist and waist and the flight distance of the ball is analyzed by an analysis unit built into the mobile terminal, which is hereby incorporated herein by reference in its entirety (Incorporation by Reference).

In the swing analysis system disclosed in the above Japanese patent, the analysis unit calculates the charging time from the time difference between the peak acceleration of the wrist and the peak of the waist acceleration, calculates wrist velocity and wrist tilt based on wrist acceleration and angular velocity, and calculates the waist velocity and waist inclination based on the waist acceleration and angular velocity. Then, in the memory, the swing time, wrist acceleration, waist acceleration, wrist speed, waist speed, wrist tilt, and waist tilt for the longest flight distance are memorized as the player's best swing.

By the way, in the technology disclosed in the above Japanese patent, it was not possible to obtain more accurate swing analysis data by calculating the swing balance (backswing time, hip turn timing, downswing time), waist speed (hip speed), waist sharpness (hip time) and waist angle (hip rotation angle).

### OBJECTS AND SUMMARY OF THE INVENTION

According to an aspect of the present disclosure, a golf swing analysis method and a golf swing analysis system are disclosed for the purpose of obtaining swing analysis data with higher accuracy than conventional. Each example disclosed in this disclosure includes one or more features described in connection with any of the other disclosed examples.

In one example, it is provided a golf swing analysis method of analyzing a golf swing with at least two or more devices includes a first device that measures arm angular velocity and a second device that measures waist angular velocity, the arm angular velocity information measured by the first device is transmitted to the second device via wireless communication, the second device detects the arm angular velocity based on the measured waist angular velocity information and the information received from the first device, and perform swing analysis by calculating waist rotation.

According to another aspect of the present disclosure, it is provided a method of analyzing a golf swing for analyzing a golf swing by displaying the angular velocity from address to the finish as a waveform based on the timing of impact, the information displayed on the waveform includes the measured start of angular velocity, when the angular velocity starts to move, the point where the sign is reversed on the waveform is determined as the point where the direction of rotation is reversed, based on information on multiple angular velocities, either the start of the arm or the start of the waist is determined as the starting position, swing analysis is performed by calculating swing parameters from these waist angular velocities, points where the direction of rotation is reversed, and determined positions.

According to yet another aspect of the present disclosure, it is provided a golf swing analysis system that transmits and receives data to a server for analysis, a first device measures data including the angular velocity of the arm and a second device measures data including the angular velocity of the hip as sensed by the sensors, the second device analyzes the swing based on the measured data and the data received from the first device by transmitting the data measured by the first device to the second device via wireless communication, determining the movement speed of the arm by synthesizing at least three or more of the data measured by the first device, if the combined value exceeds a predetermined threshold, the swing is analyzed by judging it as an impact.

### BRIEF DESCRIPTION OF THE DRAWINGS

FIG. 1 is an explanatory diagram showing an outline of a golf swing analysis system according to an embodiment of the present invention.

FIG. 2 is a diagram showing the front of a user performing a swing motion.

FIG. 3 is a diagram showing the back of a user performing a swing motion.

FIG. 4 is a plan view of a smartwatch.

FIG. 5 is a block diagram showing the electrical configuration of a smartwatch.

FIG. 6 is a plan view of a smartphone.

FIG. 7 is a block diagram showing an electrical configuration of a smartphone.

FIG. 8 is a block diagram showing an electrical configuration of the head measuring device and the foot measuring device.

FIG. 9 is a processing flowchart showing a golf swing analysis method according to an embodiment of the present disclosure.

FIG. 10 is a diagram showing waveforms of arm acceleration and angular velocity, and hip angular velocity waveforms.

FIG. 11 is a diagram showing waveforms of arm acceleration and angular velocity.

FIG. 12 is a diagram showing waveforms of arm acceleration and waist angular velocity.

FIG. 13 is a diagram showing waveforms of arm acceleration and angular velocity and hip angular velocity waveforms in analysis data 1.

FIG. 14 is a diagram showing waveforms of arm acceleration and angular velocity and hip angular velocity waveforms in analysis data 2.

FIG. 15 is a diagram showing waveforms of arm acceleration and angular velocity and hip angular velocity waveforms in analysis data 3.

### DETAILED DESCRIPTION

### Mode for Carrying Out the Invention

Preferred embodiments of the present invention will be described with reference to the accompanying drawings. The embodiments described below do not limit the content of the present invention described in the claims. Moreover, not all of the configurations described below are essential requirements of the present invention.

### <Golf Swing Analysis System 100>

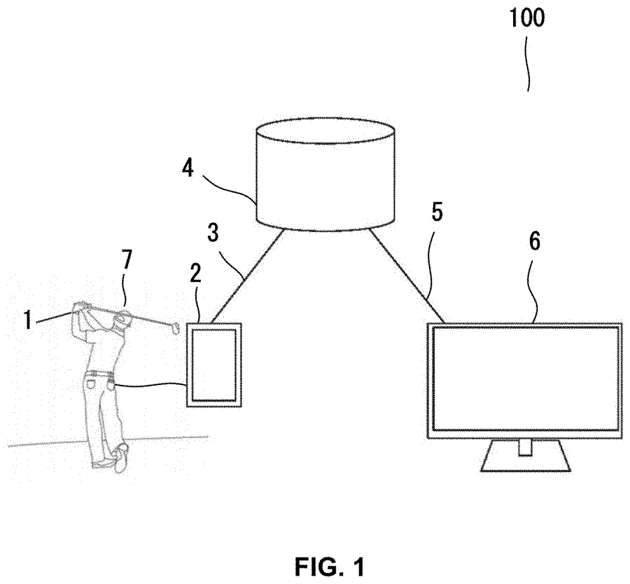

In embodiments of the present disclosure, the golf swing analysis system 100 shown in FIG. 1 includes a smart watch 1 and a smartphone 2 worn by a user 7 during an actual round at a golf course, a server 4 that enables exchange of various data with smartphone 2 via communication means 3, a play display terminal 6 that allows the user 7 to input operations and view the display, and exchange various data with the server 4 via the communication means 5 as main components.

In the golf swing analysis system 100 according to the embodiment of the present disclosure, as the sensor sensed, the smart watch 1 measures data including the angular velocity of the arm of the user 7, and the smartphone 2 measures data including the angular velocity of the waist 63 of the user 7, by transmitting the data measured by the smartwatch 1 to the smartphone 2 via wireless communication, the smartphone 2 analyzes the swing based on the measured data and the data received from the smartwatch 1, the movement speed of the arm is determined by synthesizing at least three or more pieces of data measured by the smart watch 1, when the combined value exceeds a predetermined threshold value, the swing is analyzed by determining that there is an impact.

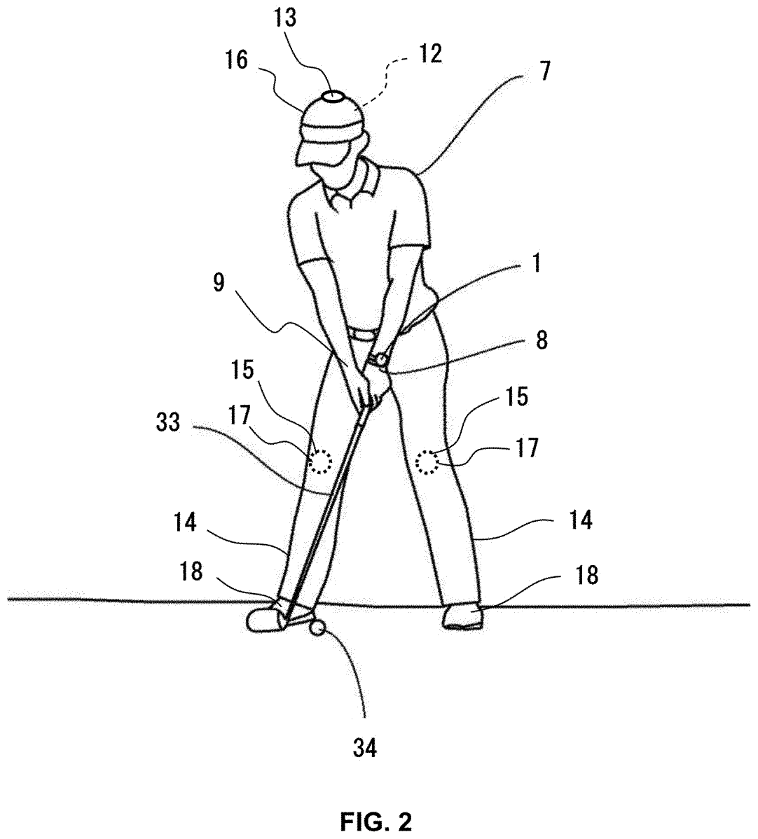

The smartwatch 1 may be attached to an arm of the user 7, specifically the wrist. In the present embodiment, as shown in FIG. 2, the smartwatch 1 is attached to the left wrist 8 of the right-handed user 7. The smartwatch 1 may be used by the left-handed user 7, and the smartwatch 1 may be attached to the right wrist.

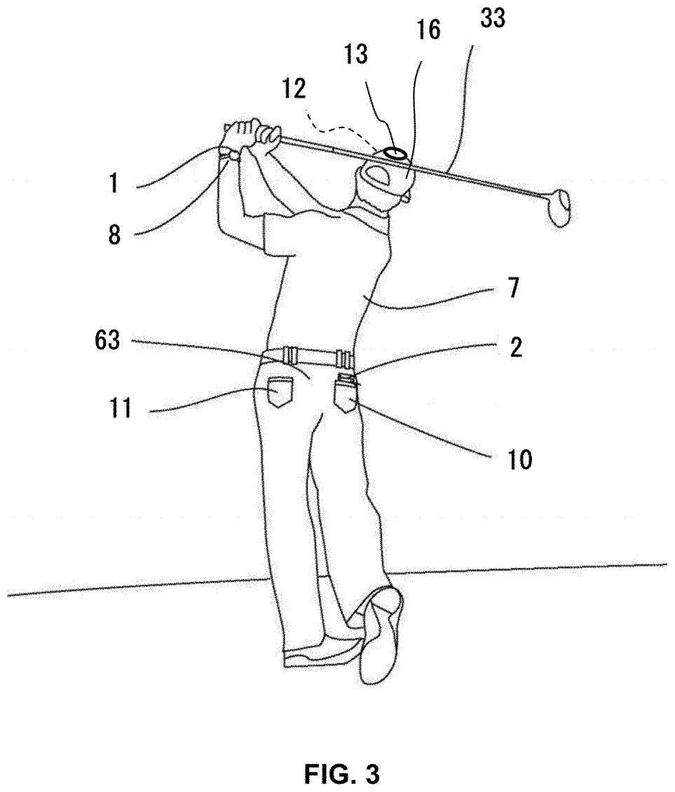

The smartphone 2 is stored in a pocket on the back of the user's 7 trousers. In this embodiment, as shown in FIG. 3, the smartphone 2 is stored in the right pocket 10 behind the pants of the user 7, but it can also be stored in the left pocket 11 behind the pants.

In this embodiment, in addition to the smartwatch 1 and the smartphone 2, the user 7 can wear the measuring device 13 on the head 12 and the user 7 can wear the measuring device 15 on the foot 14. The measuring device 13 is attached to the cap 16 of the user 7 in this embodiment. The measuring device 15 is worn on the knee 17 of the user 7 in this embodiment, but can also be worn on the shoe 18 of the user 7.

In this embodiment, the smartwatch 1 corresponds to the “first device”, the smartphone 2 corresponds to the “second device”, the measuring device 13 corresponds to the “third device”, and the measuring device 15 corresponds to the “fourth device”.

Hereinafter, each component of the golf swing analysis system 100 according to the embodiment of the present disclosure will be described with reference to FIG. 1 to FIG. 8.

### <Smartwatch 1>

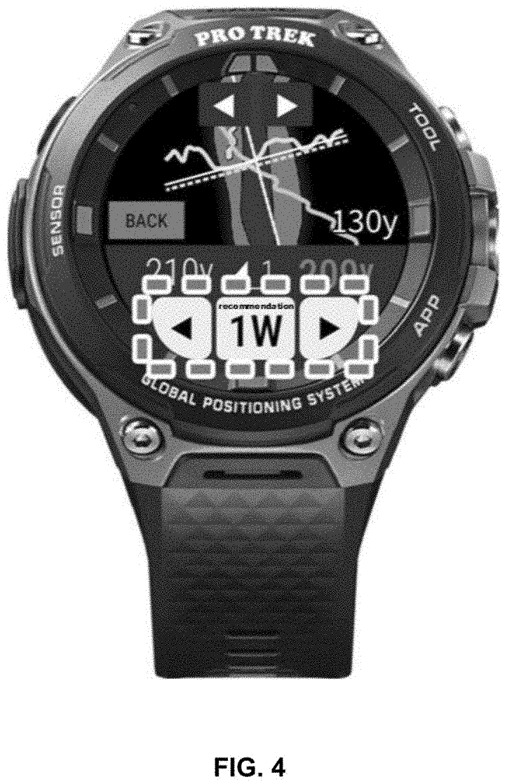

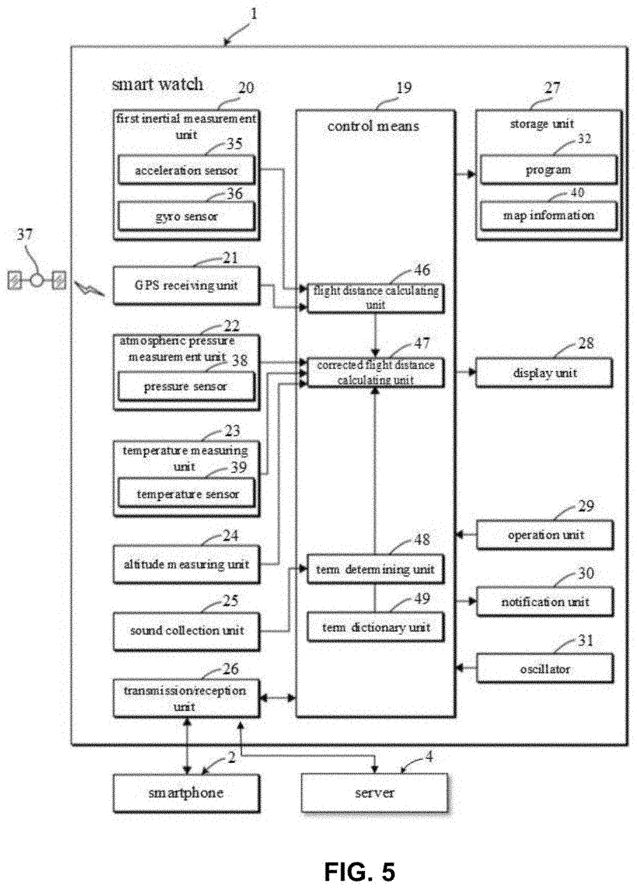

As shown in FIG. 5, the smartwatch 1 shown in FIG. 4 includes a control means 19, a first inertial measurement unit 20, a GPS (Global Positioning System) receiving unit 21, an atmospheric pressure measurement unit 22, a temperature measurement unit 23, an altitude measurement unit 24, a sound collection unit 25, a transmission/reception unit 26, a storage unit 27, a display unit 28, an operation unit 29, a notification unit 30, and an oscillator 31.

The control means 19 includes a CPU (Central Processing Unit) and controls the entire smartwatch 1 based on a program 32 stored in the storage unit 27. When the CPU executes arithmetic processing according to the program 32, each function of the smartwatch 1 is realized. The program 32 includes a flight distance correction program for correcting a flight distance of the ball 34 hit by the user 7 by performing the swing motion of the golf club 33, waveform data of acceleration and angular velocity of the left wrist P1 when user 7 performs the swing motion of the golf club 33, a play data transmission program for sending the waveform data of the acceleration and the angular velocity of the left wrist 8 when the user 7 performs the simulated swing motion to the smartphone 2 which is the measurement means of the virtual play system and the like.

The first inertial measurement unit 20 incorporates an acceleration sensor 35 and a gyro sensor 36, both of which are inertial sensors, as detection means for detecting the motion of the user 7. The acceleration sensor 35 can measure the acceleration in an orthogonal triaxial direction on the left wrist 8 of the user 7 and the gyro sensor 36 can measure the angular velocity around each of the three orthogonal axes on the left wrist 8 of the user 7. The first inertial measurement unit 20 measures the acceleration and the angular velocity of the left wrist 8 during a series of the swing motions of the user 7 wearing the wristwatch smartwatch 1. Acceleration information and angular velocity information measured by the first inertial measurement unit 20 are sent to the control means 19 as the acceleration waveform and the angular velocity waveform of the left wrist 8 during the swing motion of the user 7, and sent to the smartphone 2 and the server 4 by the transmission/reception unit 26.

The GPS receiving unit 21 constitutes a position measuring unit that acquires a current position of the wristwatch smartwatch 1 and wirelessly receives radio waves from a plurality of artificial satellites 37 to measure a three-dimensional position (longitude, latitude and altitude) of the smartwatch 1 or a user 7 wearing the smartwatch 1 and thus the player P wearing the wristwatch type terminal 1 and send a position information to the control means 19. A position detecting device other than the GPS receiving unit 21 may also be used as long as it can detect the current position of the smartwatch 1. In addition, an atomic clock is mounted on the artificial satellite 37. An extremely accurate time signal wave is transmitted from the artificial satellite 37 at a specific frequency, and a time axis of the smartwatch 1 is defined by receiving this by the GPS receiving unit 21. The GPS receiving unit 21 and the artificial satellite 37 function as the position measuring unit.

The atmospheric pressure measuring unit 22 incorporates a pressure sensor 38 and measures atmospheric pressure using the pressure sensor 38. Measured atmospheric pressure information is sent to the control means 19.

The temperature measuring unit 23 incorporates a temperature sensor 39 using a thermistor (not shown), and measures atmospheric temperature by the temperature sensor 39. Measured atmospheric temperature information is sent to the control means 19.

The altitude measurement unit 24 calculates height above sea level (altitude) (hereinafter, referred to as “altitude”) at the current position based on the amount of change in the atmospheric pressure measured by the pressure sensor 38 using the pressure sensor 38 incorporated in the atmospheric pressure measurement unit 22 and sends altitude information of the current position to the control means 19. The altitude measurement unit 24 converts change in the atmospheric pressure to calculate the relative altitude, and when the atmospheric pressure changes due to meteorological conditions, the altitude of the measured value also changes. Therefore, more accurate altitude can be measured by adjusting the altitude of the altitude measuring unit 24 at a place where the accurate altitude can be known. For example, by adjusting the altitude at a place in the golf course where the exact altitude can be known before the round, it is possible to measure the altitude more accurately during the subsequent play. As the altitude at the current position of the user 7, the altitude of the three-dimensional position (longitude, latitude and altitude) of the user 7 received by the GPS receiving unit 21 may be used.

The sound collection unit 25 collects external sounds and sends them as voice information to the control means 19, and the sound collection unit 25 is, for example, a microphone. The sound collection unit 25 of the present embodiment is assumed to collect the sound of the user 7.

The transmission/reception unit 26 enables bidirectional communication with another device, for example, the smartphone 2 via a wireless communication means. Therefore, the smartwatch 1 can send and receive various information to and from the smartphone 2 and the like.

The storage unit 27 is configured by using various storage devices such as a magnetic hard disk device and a semiconductor storage device and can write and read various information such as actual play data and simulated play data including the acceleration information and the angular velocity information measured by the first inertial measurement unit 20, the position information of the smartwatch 1 received by the GPS receiving unit 21, the atmospheric pressure information measured by the atmospheric pressure measuring unit 22, the temperature information measured by the temperature measurement unit 23, the altitude information measured by the altitude measurement unit 24 and the audio information input from the sound collection unit 25. Further, map information 40 of the golf course is stored in advance in the storage unit 27. The map information 40 is a two-dimensional map or a three-dimensional map including position coordinate information, and can be changed, added, deleted, or updated.

The display unit 28 receives a display control signal from the control means 19 and performs various displays such as the current position of the smartwatch 1. As shown in FIG. 4, the display unit 28 is composed of a liquid crystal module and a liquid crystal panel exposed on a front surface of a main body of the smartwatch 1.

The operation unit 29 includes a plurality of buttons 41, 42, 43 and 44, and the display unit 28 is a touch panel 45 and a surface portion thereof also functions as the operation portion 29. The number of buttons 41, 42, 43, 44 is an example and can be increased or decreased.

The notification unit 30 notifies the player P of the information and the like stored in the storage unit 27 by voice, and is, for example, a speaker. The notification unit 30 functions as an output unit when presenting swing information by voice or vibration. The output unit in this case is composed of, for example, a speaker that outputs sound and/or a vibrator that generates vibration.

The oscillator 31 sends a clock signal generated at a predetermined cycle to the control means 19, and is composed of, for example, a silicon oscillator, a ceramic oscillator, a crystal oscillator, or the like.

The control means 19 includes a flight distance calculating unit 46, a corrected flight distance calculating unit 47, a term determination unit 48 and a term dictionary unit 49.

The flight distance calculating unit 46 calculates the actual flight distance of the ball 34 hit against the head of the golf club 33 when the user 7 swings the golf club 33. The corrected flight distance calculating unit 47 calculates a corrected flight distance from the actual flight distance of the ball 34 hit by the user 7, taking into account altitude, air temperature, atmospheric pressure, and conditions at the shot point. The term determining unit 48 determines the voice information sent from the sound collection unit 25. The term dictionary unit 49 stores pre-registered terms.

### <Smartphone 2>

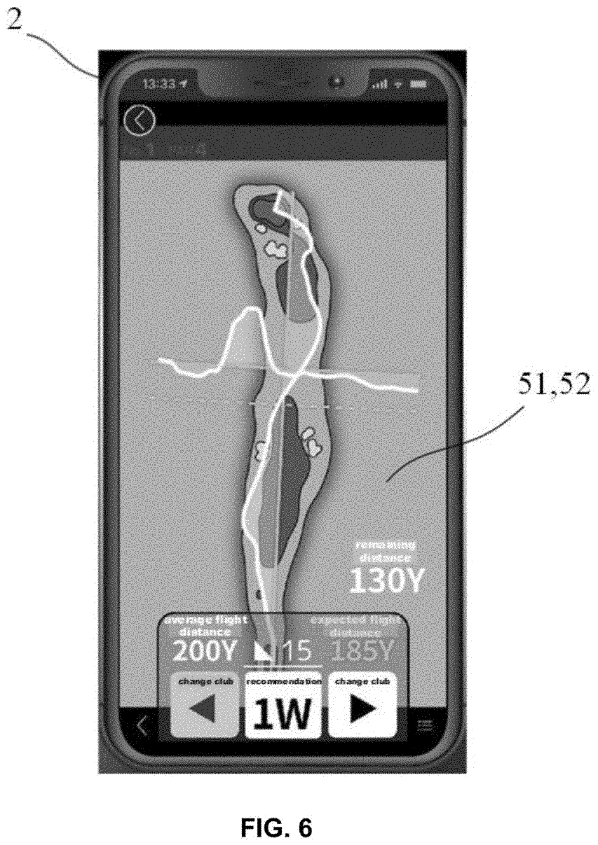

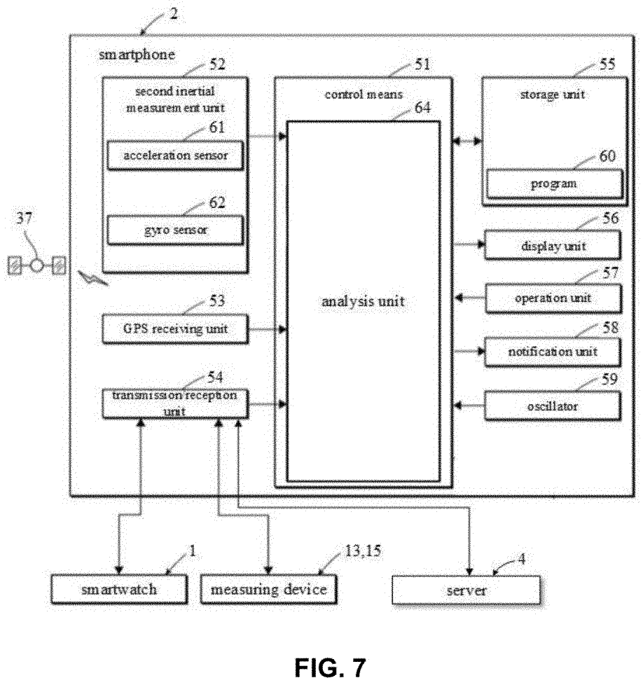

As shown in FIG. 7, the smartphone 2 shown in FIG. 6 includes a control means 51, a second inertial measurement unit 52, a GPS (Global Positioning System) receiving unit 53, a transmission/reception unit 54, a storage unit 55, a display unit 56, an operation unit 57, a notification unit 58 and an oscillator 59.

The control means 51 includes a CPU (Central Processing Unit) and controls the entire smartphone 2 based on the program 60 stored in the storage unit 55. When the CPU executes arithmetic processing according to the program 60, each function of the mobile terminal 2 is realized.

The second inertial measurement unit 52 incorporates an acceleration sensor 61 and a gyro sensor 62, both of which are inertial sensors, as detection means for detecting the motion of the user 7. The acceleration sensor 61 can measure the acceleration in an orthogonal triaxial direction and the gyro sensor 62 can measure the angular velocity around each of the three orthogonal axes. The second inertial measurement unit 52 measures the acceleration and the angular velocity of the waist 63 of the user 7 by the user 7 performing the swing operation in a state where the smartphone 2 is housed in the right pocket 10 (as shown in FIG. 3).

The GPS receiving unit 53 constitutes a position measuring unit that acquires a current position of the smartphone 2 and wirelessly receives radio waves from a plurality of artificial satellites 37 to measure a three-dimensional position (longitude, latitude and altitude) of the smartphone 2 and send the position information to the control means 51.

The transmission/reception unit 54 enables bidirectional communication between the smartwatch 1 and the smartphone 2 and between the measuring device 13, 15 and the smartphone 2 via a wired or wireless short-range communication means.

The storage unit 55 is configured by using various storage devices such as a magnetic hard disk device and a semiconductor storage device and can write and read various information such as actual play data acquired from the smartwatch 1, the smartphone 2 and the measuring device 13, 15, respectively, in addition to the position information of the smartphone 2 received by the GPS receiving unit 53.

The display unit 56 is composed of a liquid crystal module and a liquid crystal panel exposed on a front surface of a main body of the smartphone 2.

The operation unit 57 receives the operation by the user 7 and sends an electrical operation signal to the control means 45. In the present embodiment, the display unit 56 is a touch panel and the surface portion of the display unit 56 functions as the operation unit 57.

Similar to the notification unit 30 provided in the smartwatch 1 described above, the notification unit 58 functions as an output unit when presenting swing information by voice or vibration. The output unit is composed of, for example, a speaker that outputs sound and/or a vibrator that generates vibration.

The oscillator 59 sends a clock signal generated at a predetermined cycle to the control means 51, and is composed of, for example, a silicon oscillator, a ceramic oscillator, a crystal oscillator, or the like.

The control means 51 has an analysis unit 64. The analysis unit 64 acquires arm acceleration and angular velocity waveform data from the smartwatch 1 and waist 63 acceleration and angular velocity waveform data from the second inertia measurement unit 52 to analyze the swing of the user 7. The swing data analyzed by the analysis unit 64 is stored in the storage unit 55 and transmitted from the transmission/reception unit 54 to the server 4.

### <Measuring Device 13>

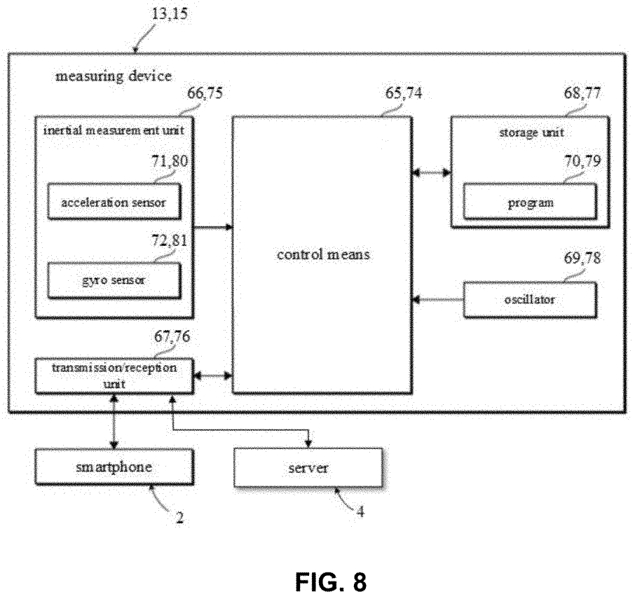

As shown in FIG. 8, the measuring device 13 shown in FIG. 1 includes a control means 65, a third inertial measurement unit 66, a transmission/reception unit 67, a storage unit 68 and an oscillator 69.

The control means 65 includes a CPU (Central Processing Unit) and controls the entire measuring device 13 based on a program 70 stored in the storage unit 68. When the CPU executes arithmetic processing according to the program 70, each function of the measuring device 13 is realized.

The third inertial measurement unit 66 incorporates an acceleration sensor 71 and a gyro sensor 72, both of which are inertial sensors, as detection means for detecting the motion of the user 7. The acceleration sensor 71 can measure the acceleration in an orthogonal triaxial direction and the gyro sensor 72 can measure the angular velocity around each of the three orthogonal axes. The third inertial measurement unit 66 measures the acceleration and the angular velocity of the head 12 of the user 7 by the user 7 performing the swing operation. Data on the movement of the head 12 is stored in the storage unit 68 and transmitted from the transmission/reception unit 67 to the smartphone 2 and the server 4.

The transmission/reception unit 67 enables bidirectional communication between the smartphone 2 and the server 4 via a wireless communication means.

The storage unit 68 is configured by using various storage devices such as a magnetic hard disk device and a semiconductor storage device and can write and read various information such as the play data including the acceleration information and the angular velocity information measured by the third inertial measurement unit 66.

The oscillator 69 sends a clock signal generated at a predetermined cycle to the control means 65, and is composed of, for example, a silicon oscillator, a ceramic oscillator, a crystal oscillator, or the like.

### <Measuring Device 15>

As shown in FIG. 8, the measuring device 15 shown in FIG. 1 includes a control means 74, a fourth inertial measurement unit 75, a transmission/reception unit 76, a storage unit 77 and an oscillator 78.

The control means 74 includes a CPU (Central Processing Unit) and controls the entire measuring device 15 based on a program 79 stored in the storage unit 77. When the CPU executes arithmetic processing according to the program 79, each function of the measuring device 15 is realized.

The fourth inertial measurement unit 75 incorporates an acceleration sensor 80 and a gyro sensor 81, both of which are inertial sensors, as detection means for detecting the motion of the user 7. The acceleration sensor 80 can measure the acceleration in an orthogonal triaxial direction and the gyro sensor 81 can measure the angular velocity around each of the three orthogonal axes. The fourth inertial measurement unit 75 measures the acceleration and the angular velocity of the foot 14 of the user 7 by the user 7 performing the swing operation. Data on the movement of the foot 12 is stored in the storage unit 77 and transmitted from the transmission/reception unit 76 to the smartphone 2 and the server 4.

The transmission/reception unit 76 enables bidirectional communication between the smartphone 2 and the server 4 via a wireless communication means.

The storage unit 77 is configured by using various storage devices such as a magnetic hard disk device and a semiconductor storage device and can write and read various information such as the play data including the acceleration information and the angular velocity information measured by the fourth inertial measurement unit 75.

The oscillator 78 sends a clock signal generated at a predetermined cycle to the control means 74, and is composed of, for example, a silicon oscillator, a ceramic oscillator, a crystal oscillator, or the like.

### <Analysis Method of Golf Swing>

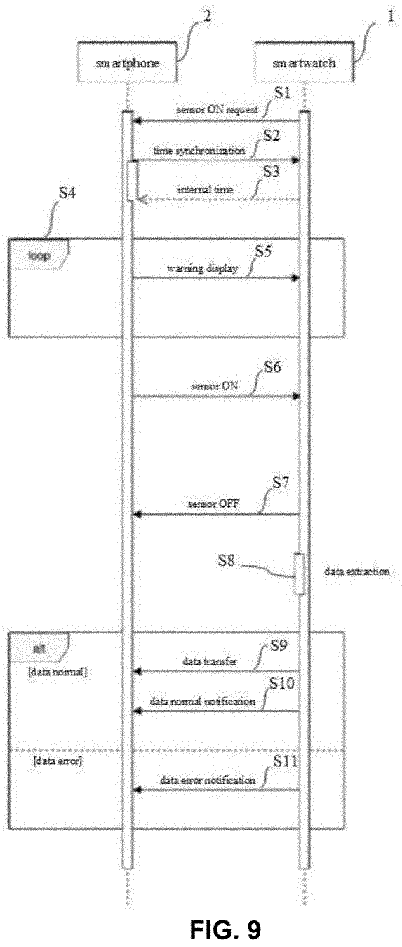

Next, a processing flow (analysis method) of golf swing analysis by the golf swing analysis system 100 according to the embodiment of the present disclosure will be described with reference to FIG. 9.

The smartwatch 1 issues a “sensor ON request” to the smartphone 2 to operate the acceleration sensor 61, the gyro sensor 62, and the like (S1). The “sensor ON request” is made by pressing the golf club selection button 83 on the display unit 28 shown in FIG. 4, for example.

The smartphone 2 synchronizes the times of the smartwatch 1 and the smartphone 2 (S2), and the smartwatch 1 checks the internal time of the smartwatch 1 and the smartphone 2 to synchronize the times (S3).

The smartphone 2 detects the orientation of the smartphone 2 with the gyro sensor 62 (S4). As a result, when the smartphone 2 is sideways stored in the pocket 10 or pocket 11 of the user 7, a warning is displayed on the smartwatch 1 (S5). If the smartphone 2 remains in sideways orientation, the smartphone 2 repeats the above warning.

The smartphone 2 turns the smartwatch 1 “sensor ON” to operate the acceleration sensor 35, the gyro sensor 36, and the like (S6).

The smartwatch 1 measures arm acceleration and angular velocity with the acceleration sensor 35 and the gyro sensor 36, and the smartphone 2 measures the acceleration and angular velocity of the waist 63 with the acceleration sensor 61 and the gyro sensor 62.

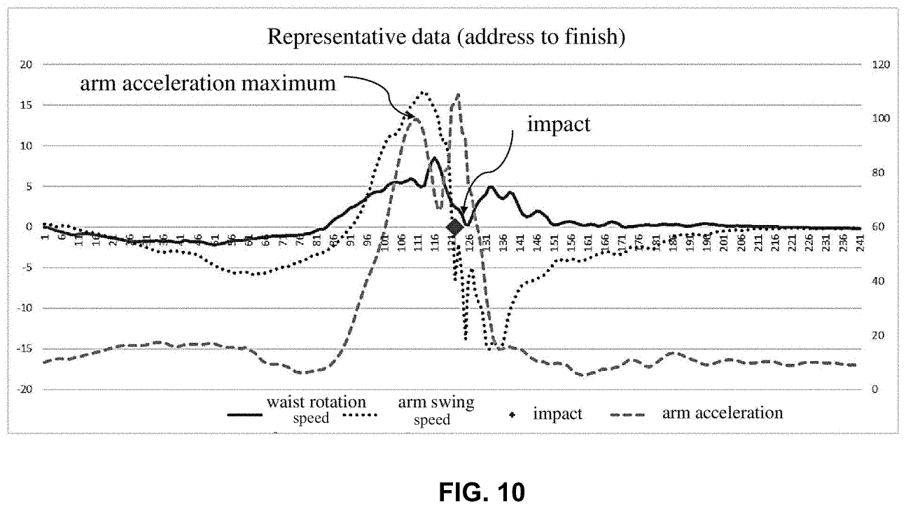

In the waveforms shown in FIG. 10, the left end of the waveform indicates the address and the right end of the waveform indicates the finish. The information displayed on the waveform includes the measurement of the start of movement of the angular velocity of the arm and waist 63. When the above angular velocity begins to move, the point where the sign is reversed on the waveform is determined as the point where the direction of rotation is reversed, from information on a plurality of angular velocities, either arm start or waist 63 start is determined as the starting position, swing parameters are calculated from the angular velocity of the waist 63, the point at which the direction of rotation is reversed, and the determined position.

As shown in FIG. 10, arm acceleration information to the information displayed in the above waveform is added, a certain point at which the angular velocity of the arm returns to the numerical value at address is set as the impact on the waveform, and the maximum position of the acceleration of the arm within a predetermined time from the impact point is obtained on the waveform.

The above impact point is determined by the following methods (1) to (4).

(1) Obtaining the peak position of the three-axis synthetic acceleration of the arm (threshold value is 70 m/s2).
(2) Confirming whether the absolute maximum position of the waist gyroY exceeds the threshold value (100 deg/s) within one second before and after the threshold value in (1) above.
(3) Obtaining the zero crossing position of the arm gyroZ within two seconds before and after the threshold value in (1) above. In addition, since the value around the impact varies, a moving average including two frames before and after (1 frame is 10 mm/s) is checked.
(4) Among the arm gyroZ intersection points before and after the threshold value in (1) above, the position is obtained, and the one closer in time to the threshold value in (1) above is taken as the impact. In (1) above, if the time from the threshold value is the same before and after, the impact is the latter.

The maximum arm acceleration position is detected by obtaining the maximum arm acceleration position before the point of impact (within 0.5 seconds before the point of impact).

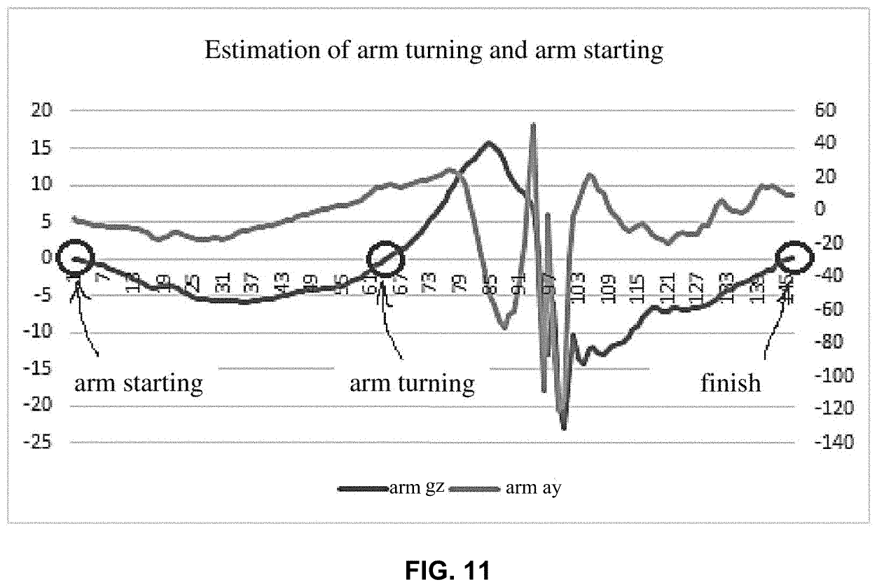

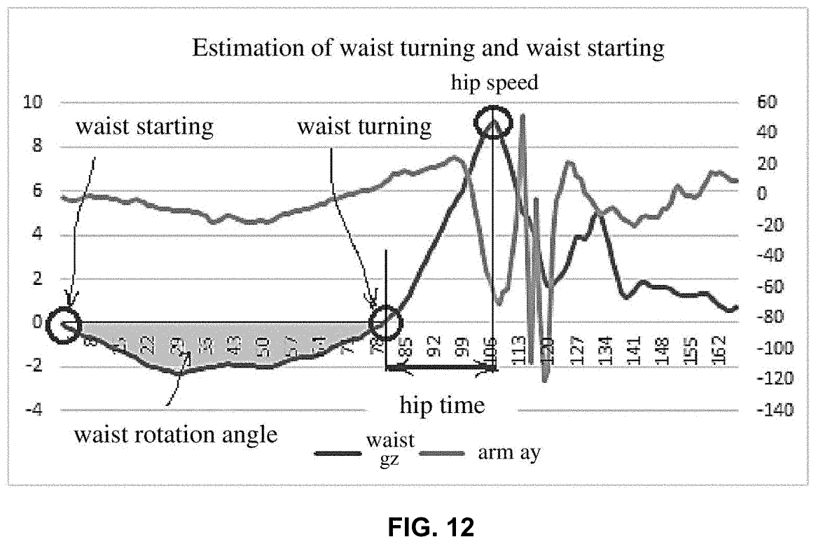

By synthesizing information on a plurality of accelerations of the arm on the above waveform, the peak position of the acceleration of the arm is obtained, around the peak position, the swing is analyzed by obtaining information on the moving speed of the waist 63, the turning of the waist 63 (FIG. 12), the turning of the arm (FIG. 11), or the downswing, and the information on the angular velocity.

On the waveform shown in FIG. 11, the arm turning position, the arm start position, and the finish position are estimated. The arm turning position is the arm gz sign reversal position before the same sign five consecutive times (50 ms) before the maximum acceleration position of the arm. The starting position of the arm is assumed to be the arm gz sign reversal position before 1 rps before the above-mentioned arm turning position. The finish position is the arm gz sign reversal position before the same sign for 10 consecutive times (100 ms) after the impact.

On the waveform shown in FIG. 12, the turning position of the waist 63 and the starting position of the waist 63 are obtained, and the rotation starting position of the waist 63 is estimated. The turning position of the waist 63 is the waist gy code reversal position before the same sign five consecutive times (50 ms) before the midpoint. The starting position of the waist 63 is before the turning position of the waist 63 and the waist gy code reversal position before 0.5 rps.

From the waveform shown in FIG. 12, the following items (1) to (4) are obtained from the angular velocity of the waist 63.

(1) Maximum movement speed of the waist 63 (hip speed)
The maximum moving speed of the waist 63 is obtained from the maximum waist gy position between the turning of the waist 63 and the point of impact.
(2) Sharpness of the waist 63 (hip time)
The time from turning of the waist 63 to the maximum position of the waist gy is obtained as sharpness of the waist 63.
(3) Angle of the waist 63 at top
Based on the address, the angular velocity of the waist 63 at the top is obtained, and by integrating this, the angle of the waist 63 at the top is obtained.
(4) Angle of the waist 63 at impact
Based on the address, the angular velocity of the waist 63 at the time of impact is obtained, and by integrating this, the angle of the waist 63 at the time of impact is obtained.

Using the items obtained above, the rotation efficiency of the waist 63 is obtained from the maximum movement speed of the waist/the angle of the waist 63 at the top, (maximum movement speed of waist 63−movement speed of waist 63 at impact)/maximum movement speed of waist 63, the maximum movement speed attenuation rate of waist 63 is obtained.

Either the starting position of the arm or the starting position of the waist 63 is calculated on the above waveform. On the above waveform, the turning time of the waist 63 and the arm turning time are calculated.

Obtaining the following items (1) to (4) and calculate the swing balance.

### (1) Backswing Time

The time from the starting position of the arms or the starting position of the waist 63, whichever is earlier, to the turning of the waist 63 is obtained as the “backswing time”.

### (2) Charging (Hip Turn Timing)

Based on the angular velocity information of the waist 63, the time from turning the waist 63 to turning the arm is obtained as “charging (hip turn timing)”.
(3) Downswing time 1
Based on the angular velocity information of the arm, the time at a predetermined position is set as the arm's turning position, and the time required to reach a predetermined position (for example, maximum arm acceleration position) is determined as “downswing time 1” based on arm acceleration information.
(4) Downswing time 2
The time from the predetermined position of acceleration of the arm to the impact is obtained as “downswing time 2”.

The swing analysis work described above is stopped when a predetermined condition is satisfied. As shown in FIG. 9, the smartwatch 1 instructs the smartphone 2 to “sensor OFF” (S7). The “predetermined condition” is any of (1) when the user 7 has moved 20 yards or more, (2) when the flight distance of the ball 34 is determined, and (3) when it is confirmed that the predetermined time has passed.

As shown in FIG. 9, data for only a predetermined period of time before and after the impact is cut out from the smartwatch 1. The “predetermined time” is the time from 5 seconds before the impact to 2 seconds after the impact.

As shown in FIG. 9, the smartwatch 1 transfers the extracted data to the smartphone 2 (S9). If the data is normal data, the smartwatch 1 notifies the smartphone 2 that the data is normal (S10). In a predetermined case, the data is determined to be abnormal data, and the smart watch 1 notifies the smartphone 2 of the data abnormality (S11). Whether or not the data is normal data is determined by detecting the movement of the arm and determining whether or not it is a swing. Determination of whether or not there is a swing is made based on whether or not a predetermined threshold value is exceeded.

### <Comparison of Analysis Data 1-3>

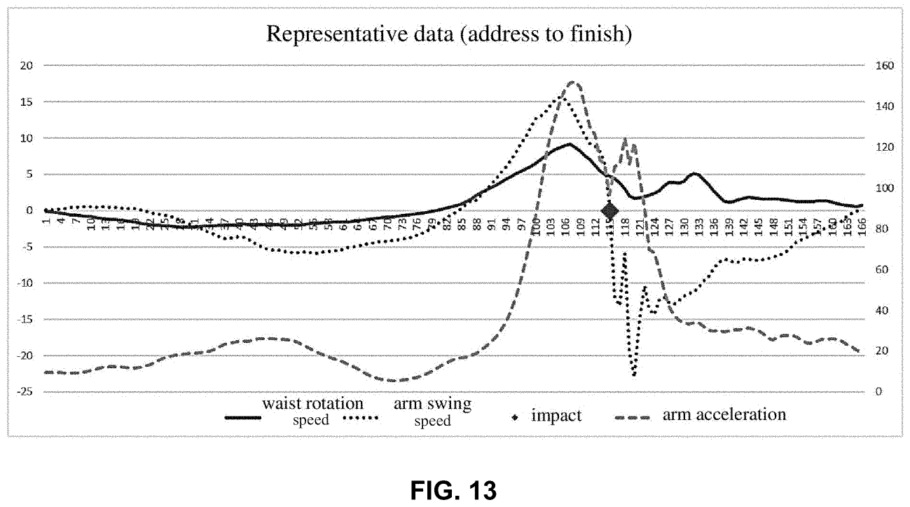

Next, with reference to FIG. 13-15, analysis data obtained by the golf swing analysis system 100 according to the embodiment of the present disclosure will be compared.

Analysis data (analysis data 1) of the swing based on the waveform of FIG. 13 is as follows.

(1) Maximum waist movement speed (hip speed): 526°/s
(2) Waist sharpness (hip time): 0.27 s
(3) Waist angle at top: 64.7°
(4) Waist angle at impact: 34.3°

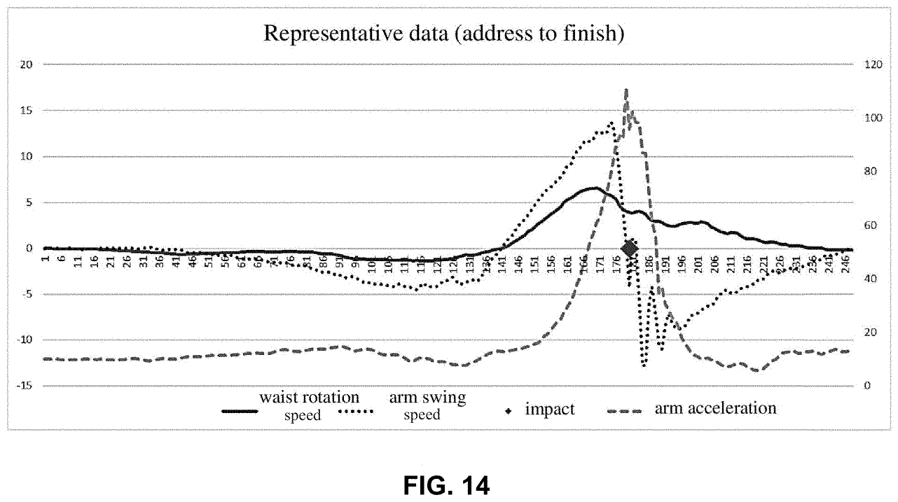

Analysis data (analysis data 2) of the swing based on the waveform of FIG. 14 is as follows.

(1) Maximum waist movement speed (hip speed): 377°/s
(2) Waist sharpness (hip time): 0.28 s
(3) Waist angle at top: 47.7°
(4) Waist angle at impact: 42.9°

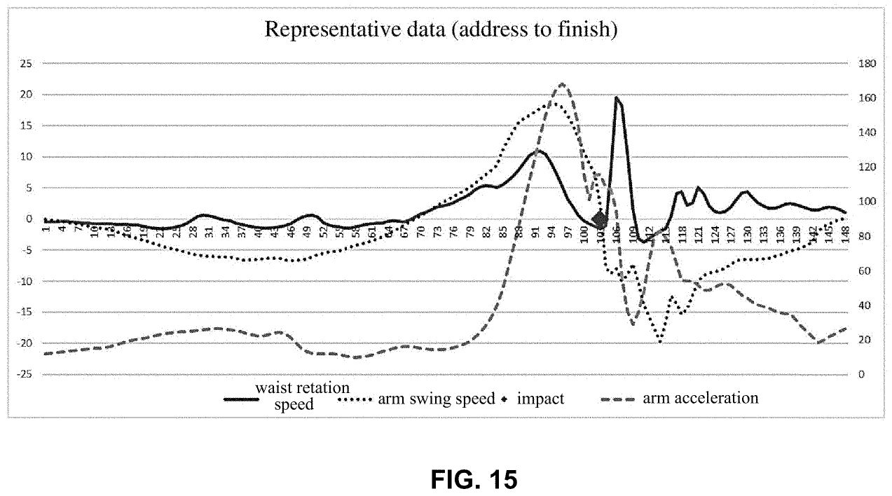

Analysis data (analysis data 3) of the swing based on the waveform of FIG. 15 is as follows.

(1) Maximum waist movement speed (hip speed): 627°/s
(2) Waist sharpness (hip time): 0.23 s
(3) Waist angle at top: 7.5°
(4) Waist angle at impact: 78.5°

The maximum movement speed of the waist is 550 to 600°/s for male pros, and the average value for amateurs is 480°/s, the sharpness of the waist is 0.2 s for male pros, and the average value for amateurs is 0.3 s or more.

In analysis data 1, the maximum movement speed of the waist is 526°/s, and the sharpness of the waist is 0.27 s, it can be said that it is a relatively ideal swing because it is close to the numerical range of the male pros and the average value of the amateur.

On the other hand, in analysis data 2, the maximum movement speed of the waist is 377°/s, and the sharpness of the waist is 0.28 s, the sharpness of the waist is close to the numerical range of the male pros and the average value of the amateur. However, the maximum movement speed of the waist is far below the numerical range of male pros and the average value of amateurs. Therefore, compared with the analysis data 1, it can be said that the swing has room for improvement.

Further, in analysis data 3, the maximum movement speed of the waist is 627°/s, and the sharpness of the waist is 0.23 s that is close to the numerical range of the male pros and the average value of the amateur. However, the maximum movement speed of the waist is out of the numerical range of the male pros and the average value of the amateurs. Therefore, compared with the analysis data 1, it can be said that the swing has room for improvement.

According to the above embodiments of the present disclosure, by calculating the swing balance (backswing time, hip turn timing, downswing time), waist speed (hip speed), waist sharpness (hip time), waist angle (hip rotation angle), it is possible to acquire swing analysis data with higher precision than before.

In the above description of representative embodiments of the invention, for the purpose of streamlining the disclosure and assisting in understanding one or more of the various aspects of the invention, it will be appreciated that various features of the invention are sometimes grouped together in a single embodiment, figure, or description thereof. This method of disclosure, however, is not to be interpreted as reflecting an intention that more features are required than are expressly recited in each claim. Rather, as the following claims reflect, inventive aspects lie in less than all features of a single, above-disclosed embodiment. Accordingly, the claims following the Detailed Description are hereby expressly incorporated into this Detailed Description of the Invention, each claim stands on its own as a separate embodiment of this invention.

Moreover, some embodiments described in this disclosure may include some features but not others that are included in other embodiments, as will be appreciated by those skilled in the art, combinations of features of different embodiments are within the scope of the invention and are meant to form different embodiments. For example, in the following claims, any of the claimed embodiments may be used in any combination.

Thus, even though one particular embodiment has been described, those skilled in the art will recognize that other and further modifications may be made without departing from the spirit of the invention, all such changes and modifications are intended to be claimed as being within the scope of the present invention. For example, functionality may be added to the block diagrams, functionality may be deleted from the block diagrams, and operations may be interchanged between functional blocks. Steps may be added or deleted from the methods described within the scope of the invention. The subject matter disclosed above should be considered illustrative and not restrictive, the appended claims are intended to cover all alterations, modifications, extensions and other implementations falling within the true spirit and scope of this disclosure. Accordingly, to the fullest extent permitted by law, the scope of the disclosure will be determined by the broadest possible interpretation of the appended claims and their equivalents, and not limited or limited by the preceding detailed description. While various implementations of the present disclosure have been described, it will be apparent to those skilled in the art that there are many more possible implementations within the scope of the present disclosure. Accordingly, the disclosure is not to be restricted except in light of the attached claims and their equivalents.

What is claimed is:

1. A virtual play system comprising:
a player terminal worn by a player,
a display terminal provided with a display unit, and
a server device capable of communicating with the player terminal and the display terminal,
wherein the player terminal includes a measurement data providing unit that transmits first measurement data obtained by measuring and quantifying motion of the player during actual play and second measurement data obtained by measuring and quantifying motion of the player during simulated play to the server device,
wherein the server device includes a virtual play data generation unit that calculates virtual play data based on the first measurement data and the second measurement data, and
wherein the display terminal displays the virtual play data.

2. The virtual play system according to claim 1, wherein the server device is configured to be capable of communicating with the player terminal and the display terminal of a plurality of players, and
wherein the display terminal is configured to be capable of displaying the virtual play data of the plurality of players.

3. The virtual play system according to claim 1, wherein the first measurement data is obtained by measuring and quantifying a swing motion when the player actually hits a ball with a golf club,
wherein the second measurement data is obtained by measuring and quantifying a simulated swing motion performed by the player without holding the golf club, and
wherein the virtual play data may be trajectory data of the ball when it is assumed that the player holds the golf club and performs the same operation as the simulated swing operation to hit the ball.

4. The virtual play system according to claim 2, wherein the first measurement data is obtained by measuring and quantifying a swing motion when the player actually hits a ball with a golf club,
wherein the second measurement data is obtained by measuring and quantifying a simulated swing motion performed by the player without holding the golf club, and
wherein the virtual play data may be trajectory data of the ball when it is assumed that the player holds the golf club and performs the same operation as the simulated swing operation to hit the ball.
